(19) United States
(12) Patent Application Publication
(10) Pub. No.: US 2022/0402064 A1
(43) Pub. Date: Dec. 22, 2022

(54) JOINING DEVICE AND JOINING METHOD

(71) Applicant: MAZDA MOTOR CORPORATION, Hiroshima (JP)

(72) Inventors: Kojiro YAMAGUCHI, Hiroshima (JP); Yoshihito FUKU, Hiroshima (JP); Motonori MORIWAKI, Hiroshima (JP); Tomoyuki IWAMOTO, Hiroshima (JP); Masanori NAKAI, Hiroshima (JP); Naoki UJIHIRA, Hiroshima (JP); Hiroki SATO, Hiroshima (JP); Yasunari MIYAMOTO, Hiroshima (JP); Yudai KOBATAKE, Hiroshima (JP)

(73) Assignee: MAZDA MOTOR CORPORATION, Hiroshima (JP)

(21) Appl. No.: 17/744,802

(22) Filed: May 16, 2022

(30) Foreign Application Priority Data
Jun. 17, 2021 (JP) 2021-100940

(51) Int. Cl. B23K 11/11; B23K 11/30; B23K 11/25

(52) U.S. Cl. CPC B23K 11/115; B23K 11/3009; B23K 11/25

(57) ABSTRACT

A joining device includes: a pair of pressing members disposed to face each other to sandwich joining target members from both sides in a stacking direction of the joining target members and configured to press the joining target members; and power supply members disposed on one or both sides in the stacking direction of the joining target members to sandwich a pressing target portion of the joining target members by the pressing members and configured to come into contact with and supply power to the joining target members. The power supply members are provided at positions not overlapping the pressing members in the stacking direction of the joining target members, and the pressing members press the joining target members while the power supply members supply power to the joining target members, thereby generating resistance heat in the pressing target portion and joining the joining target members.

### CROSS-REFERENCE TO RELATED APPLICATION

This application claims priority to Japanese Patent Application No. 2021-100940 filed on Jun. 17, 2021, the entire disclosure of which is incorporated by reference herein.

### BACKGROUND

The present invention relates to a joining device and a joining method.

In a manufacturing process of bodies of vehicles and the like, spot welding is performed while expansion and scattering of molten metal accompanying melting of a joining interface is substantially prevented by sandwiching a plurality of joining target members stacked between a pair of electrodes, energizing the joining object to generate resistance heat, and pressing a welding target portion.

In such spot welding, the scattering of molten metal becomes a problem when a molten portion increases beyond an extent of influence of pressing. Meanwhile, for example, in WO 2017/073793, it has been proposed to reduce scattering of molten metal by a method in which a joining target member is sandwiched by an electrode body provided with a pressing member on the outer periphery of an electrode tip, and a pressure of the electrode tip and a pressure of the pressing member are independently controlled. Further, in order to reduce a fringing phenomenon caused by a change in a contact state between a joining target member and a power supply unit in a welding process and an increase or a change in a current path in the joining target member along with the change in the contact state, a spot welding electrode having an uneven portion its distal end has been proposed in Japanese Unexamined Patent Publication No. 2020-082092, for example.

### SUMMARY

However, in such spot welding, the pressing portion and the power supply unit of the electrode are integral. Arc discharge thus occurs between the joining target member and the power supply unit due to the fringing phenomenon. For this reason, when the plurality of welding target portions is continuously welded, wear and loss of the electrode progress, and a welding state due to power supply and pressing is not stabilized. The electrode that supplies power is near the welding target portion that melts and reaches a high temperature, heat is removed from the welding target portion by water cooling for protecting the power supply unit. In other words, this working process is inefficient because heating and cooling are performed in parallel.

The present invention has been made in view of such problems, and an object of the present invention is to provide a joining device and a joining method in which deterioration of a power supply member is substantially reduced to stabilize a current path in the joining object, and a decrease in energy efficiency is substantially prevented.

In order to achieve the above object, a joining device disclosed herein is a device that joins a plurality of joining target members being stacked. The joining device includes: a pair of pressing members disposed to face each other to sandwich the plurality of joining target members from both sides in a stacking direction of the plurality of joining target members and configured to press the plurality of joining target members; and a plurality of power supply members disposed on one or both sides of in the stacking direction of the plurality of joining target members to sandwich a pressing target portion of the plurality of joining target members by the pressing members, the plurality of power supply members being configured to come into contact with and supply power to the joining target members, wherein the power supply members are provided at positions not overlapping the pressing members in the stacking direction of the plurality of joining target members, and the pressing members press the plurality of joining target members while the power supply members supply power to the plurality of joining target members, thereby generating resistance heat in the pressing target portion and joining the plurality of joining target members.

In the present technique, the power supply members that supply power to the joining target members and the pressing members that press the joining target members are separated and disposed at positions not overlapping in the stacking direction. It is thus possible to substantially prevent deformation of the joining target members at portions in contact with the power supply members. It is therefore possible to stably generate a current path in the joining target members, and by reducing a rapid change in the current path, occurrence of arc discharge can be substantially prevented, and wear and loss of the power supply members can be substantially prevented. Further, the current path passing through the pressing target portions can be stabilized and a material that is not suitable for a power supply function can be applied. This allows substantial prevention of heat dissipation due to heat conduction, efficient consumption of energy in the pressing target portions, and improvement in energy efficiency. It is therefore possible to provide a joining device in which deterioration of the power supply members is substantially prevented, and a decrease in the energy efficiency is substantially prevented with a simple configuration.

The power supply members may include a first power supply member disposed on one side in the stacking direction of the plurality of joining target members and a second power supply member disposed on the other side in the stacking direction of the plurality of joining target members.

The present technique allows the current path to be formed from one side to the other side in the stacking direction of the joining target members and allows the current path to more reliably pass through the pressing target portions. In the joining target members, a current density becomes sparse toward the portions in contact with the power supply members, and the current density becomes dense toward a region corresponding to the portions in contact with the pressing members; thus a calorific value in the pressing target portions can be secured. Such control of the current density makes it possible to further enhance effects of stabilizing the current path and improving the energy efficiency.

The first power supply member and the second power supply member may each have a contact portion extending along surfaces of the joining target members, and the contact portion of the first power supply member and the contact portion of the second power supply member face each other with the pressing target portion interposed therebetween.

In the present technique, in the joining target members, a current density becomes sparse toward the portions in contact with the power supply members, and the current density becomes dense toward the region corresponding to the portions in contact with the pressing members. Thus, a calorific value in the pressing members can be secured and the present technique is more suitably implemented.

The pressing members and the power supply members adjacent to each other in a surface direction of the joining target members may be provided at a distal end of an electrode body.

In the present technique, while both the pressing members and the power supply members are provided at the distal end of the electrode body, the power supply members that supply power to the joining target members and the pressing members that press the joining target members can be separated from each other, and the joining target members can be substantially prevented from being deformed at the portions in contact with the power supply members. Thus, the joining device can be more suitably implemented with a simple configuration.

The pressing members may each be provided with a pressing member support between the corresponding pressing member and the electrode body, the pressing member support being elastically deformable in the stacking direction of the plurality of joining target members.

The present technique makes it possible to control timing of bringing the pressing members into contact with the joining target members and control of the pressing by the elastic deformation of the pressing member support; thus the present technique has more enhanced versatility and can be more suitably implemented.

The power supply members may each be provided with a power supply member support between the corresponding power supply member and the electrode body, the power supply member support being elastically deformable in the stacking direction of the plurality of joining target members.

The present technique makes it possible to control timing of bringing the power supply members into contact with the joining target members and control of a contact state of the power supply members and the joining target members by the elastic deformation of the power supply member support with a simple configuration; thus the present technique has more enhanced versatility and can be more suitably implemented.

The pressing members may each be made of a conductor, and an insulating member is provided between the power supply members and the pressing members.

In the present technique, even if the pressing members are each made of a material that easily conducts electricity, it is still possible to generate a current path at a desired position of the joining target members; thus the current path can be more reliably controlled with a simple configuration.

The power supply members may include a joining power source configured to generate resistance heat in the pressing target portion, and a monitoring power source configured to check an energization state of the power supply members to the joining target members.

In the present technique, by supplying power between the power supply members by the monitoring power source, it is possible to check the energization state of the power supply members to the joining target members and check an appropriate pressing condition in advance. Then, the joining target members can be joined more suitably by supplying power by the joining power source with use of the checked pressing condition.

A joining method disclosed herein is a method of joining a plurality of joining target members being stacked. The joining method includes, by using a pair of pressing members disposed to face each other to sandwich the plurality of joining target members from both sides in a stacking direction of the plurality of joining target members and configured to press the plurality of joining target members, and using a plurality of power supply members disposed on one or both sides of in the stacking direction of the plurality of joining target members to sandwich a pressing target portion of the plurality of joining target members by the pressing members, the plurality of power supply members being configured to come into contact with and supply power to the joining target members, pressing the plurality of joining target members by the pressing members and supplying power to the plurality of joining target members at positions not overlapping the pressing members in the stacking direction of the plurality of joining target members by the power supply members, to generate resistance heat in the pressing target portion and join the plurality of joining target members.

In the present technique, power supply and pressing are performed in a state where the power supply members that supply power to the joining target members and the pressing members that press the joining target members are separated. It is thus possible to substantially prevent deformation of the joining target members at portions in contact with the power supply members. It is therefore possible to stabilize the current path in the joining target members, and by reducing a rapid change in the current path, occurrence of arc discharge can be substantially prevented, and wear and loss of the power supply members can be substantially prevented. Further, the current path can be stabilized and a material that is not suitable for the power supply function can be applied. This allows substantial prevention of heat dissipation due to heat conduction, efficient consumption of heat in the pressing target portion, and improvement in energy efficiency. It is therefore possible to provide a joining method in which deterioration of an electrode is substantially prevented, the current path in the joining object is stabilized, and a decrease in the energy efficiency is substantially prevented with a simple configuration.

The first power supply member and the second power supply member may each have a contact portion extending along surfaces of the joining target members, and the contact portion of the first power supply member and the contact portion of the second power supply member face each other with the pressing target portion interposed therebetween.

The present technique allows the current path to be formed from one side to the other side in the stacking direction of the joining target members and allows the current path to more reliably pass through the pressing target portions. Further, in the joining target members, a current density becomes sparse in a region close to the portions in contact with the power supply members, and the current density becomes dense toward a region corresponding to portions in contact with the pressing members; thus a calorific value in the pressing target portion can be secured. Such control of the current density makes it possible to further enhance effects of stabilizing the current path and improving the energy efficiency.

The power supply members may have a contact portion that comes into contact with the joining target members and is extending in a direction substantially perpendicular to the pressing target portion in a plan view.

In the present technique, in the joining target members, a current density becomes sparse in a region close to the portions in contact with the power supply members, and the current density becomes dense toward the region corresponding to the portions in contact with the pressing members. Thus, a calorific value in the pressing members can be secured and the present technique is more suitably implemented.

The power supply members may supply power by using the pressing members each made of a conductor in a state where an insulating material is interposed between the plurality of joining target members.

In the present technique, even if the pressing members are each made of a material that easily conducts electricity, it is still possible to generate a current path at a desired position of the joining target members by interposing the insulating material between the joining target members. Thus, the current path can be more reliably controlled with a simple configuration.

The power supply members may include a joining power source configured to generate resistance heat in the pressing target portion, and a monitoring power source capable of checking an energization state of the power supply members to the joining target members, The joining method may further include an energization checking step of checking an energization state of the plurality of joining target members by gradually changing a pressing force by the pressing members in a state where power is supplied between the power supply members by the monitoring power source, and a joining step of supplying power between the power supply members by the joining power source under a condition checked in the energization checking step.

In the present technique, it is possible to check an optimum construction condition by changing the pressing force by the pressing members while monitoring the energization state with the monitoring power source in advance. By constructing with the joining power source under the optimum construction condition, the pressing target portions are secured as the current path, and then power is supplied. Therefore, the current path is easily controlled, and the present technique is more suitably implemented.

As described above, in the present disclosure, since the power supply members that supply power to the joining target members and the pressing members that press the joining target members are separated, it is possible to prevent or reduce deformation of the joined members at the location abutting on the power supply members. As a result, the current path in the joining target members can be stabilized, and wear and loss of the power supply members can be prevented or reduced. By stabilizing the current path, heat can be efficiently consumed in the pressing target portions, and the energy efficiency can be improved.

### BRIEF DESCRIPTION OF DRAWINGS

FIG. 1 is a schematic sectional view of a configuration of a joining device according to a first embodiment of the present invention.

FIG. 2 is a schematic perspective view of an example of an electrode body.

FIG. 3 is a schematic sectional view of a configuration of a joining device according to a second embodiment of the present invention.

FIG. 4 is a schematic plan view of a current path in a joining object.

FIG. 5 is a schematic sectional view of a joining device according to a third embodiment.

FIG. 6 is a schematic sectional view of a joining method according to a fourth embodiment.

FIG. 7 is a schematic sectional view of a configuration of a joining device according to a fifth embodiment.

FIG. 8 is a schematic sectional view of a configuration of a joining device according to a sixth embodiment.

FIG. 9 is a schematic sectional view of the configuration of the joining device according to the sixth embodiment.

FIG. 10 is a flowchart illustrating an example of a joining procedure.

FIG. 11 is a schematic sectional view of a configuration of a joining device according to a seventh embodiment.

FIG. 12 is a schematic sectional view of the configuration of the joining device according to the seventh embodiment.

### DETAILED DESCRIPTION

Hereinafter, embodiments of the present disclosure will be described in detail with reference to the drawings. The following description of preferred embodiments is merely exemplary in nature and is not intended to limit the present disclosure, its applications, or its use.

### First Embodiment

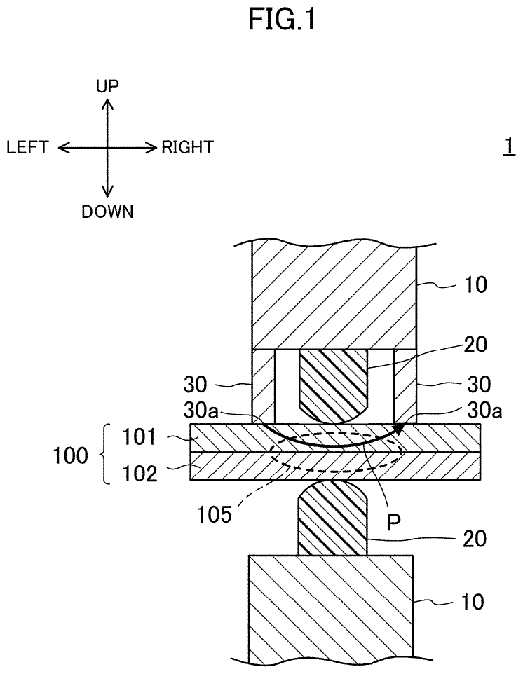

FIG. 1 is a schematic sectional view of a configuration of a joining device according to a first embodiment of the present invention. A joining device 1 according to the present embodiment is a device that joins a joining object 100 including a plurality of joining target members 101 and 102 stacked on top of one another. As illustrated in FIG. 1, the joining device 1 includes a pair of pressing members 20 and 20 disposed to face each other so as to sandwich two joining target members 101 and 102 from both sides in a stacking direction of the joining target members 101 and 102 and includes a plurality of power supply members 30 disposed to sandwich a pressing target portion 105 of the joining object 100 pressed by the pressing members 20. The pressing members 20 press the joining object 100, and the power supply members 30 supply power to the joining object 100, thereby generating resistance heat at the pressing target portion 105 of the joining object 100 and melting and joining the plurality of joining target members 101 and 102.

For convenience of description, a mechanical structure other than a cross section of a main part including the pressing members, the power supply members, and the joining object is not illustrated in the drawings. The joining device 1 includes multiple components other than those illustrated in the drawings, for example, a drive unit that drives the pressing members, a power source connected to the power supply members, and the like, but illustration and detailed description thereof are omitted.

In the present specification, for convenience, directions in the main part may be as follows. Specifically, as illustrated in FIG. 1, a direction in which the joining target members 101 and 102 are stacked (stacking direction) may be referred to as an up-down direction, and a direction perpendicular to the up-down direction and corresponding to a surface direction of the joining target members 101 and 102 may be referred to as a left-right direction.

The joining target members 101 and 102 are each a member having a plate-shaped joining target portion, and is, for example, a member made of metal such as aluminum, steel, iron, or an alloy thereof, a member made of a carbon fiber-reinforced composite metal material, or the like. Specifically, these members are members that may be joined to each other in, for example, vehicle components for motor vehicles, such as a front panel, a floor panel, a rear panel, a side sill, a tunnel reinforcement, a cross member, a frame, and an outer panel, other vehicle components such as aircraft and trains, building materials, industrial products, and the like. The plurality of joining target members may be collectively referred to as the joining object 100.

As illustrated in FIG. 1, the pressing members 20 are disposed on upper and lower sides of the joining object 100, and are provided so as to be able to press the joining object 100 with the joining object 100 interposed therebetween. The pair of the pressing members 20 and 20 are disposed to face each other so as to overlap each other in the up-down direction, and are configured to be movable up and down toward the joining object 100. Each of the pressing members 20 presses the joining object 100 by moving up and down, and generates a pressing target portion 105 in the joining object 100. The pressing target portion 105 is a portion that is melted by resistance heat generated by energization of the power supply members 30 and 30 and is pressed by the pressing members 20 and 20 to become a joined portion (welding target portion).

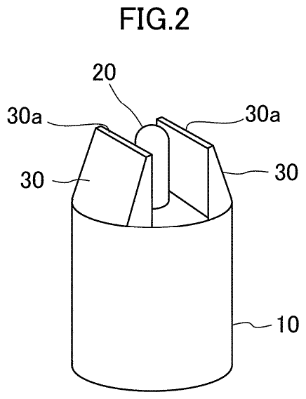

When a cylindrical heat-insulating member having a hemispherical distal end which comes into contact with the surface of either one of the joining target member 101 or 102 is used for each of the pressing members 20 as illustrated in FIG. 2, the influence of the pressing members 20 on the shapes of the surfaces of the joining target members 101 and 102 can be minimized However, a shape and material of the pressing member is not limited. A square-shaped pressing members can be used to reliably press the pressing target portion 105, for example.

The power supply members 30 are disposed on one side in the up-down direction of the joining object 100 and on both sides in the left-right direction of one of the pressing members 20 so as to sandwich the pressing target portion 105 pressed by the pressing members 20. In the present embodiment, specifically, two power supply members 30 and 30 are disposed with a space apart on left and right sides of the pressing member 20 provided above the joining object 100 (on one side in the stacking direction).

The power supply members 30 are configured to be movable up and down toward the joining object 100. The power supply members 30 come into contact with the surface of the joining object 100 by moving up and down, and can supply power into the joining object 100 from contact portions 30a in contact with the surface of the joining target member 101 or 102. As illustrated in FIG. 2, the contact portions 30a extend along the surfaces of the joining target members. Each of the power supply members 30 and 30 is provided at a position not overlapping the pressing member 20 in the up-down direction. However, when the power supply members 30 and 30 are energized together with the pressing by the pressing member 20, for example, as indicated by an arrow in FIG. 1, a current path P is generated in the left-right direction in the joining object 100, and the current path P passes through the pressing target portion 105.

The pressing members 20 and the power supply members 30 may be provided independently in the joining device 1, but as illustrated in FIGS. 1 and 2. In one preferred embodiment, the pressing member 20 and the power supply members 30 adjacent in the left-right direction are provided at a distal end of one electrode body 10. The electrode body 10 is configured to be movable up and down by a driving device (not illustrated). The pressing member 20 and the power supply members 30 may move up and down together by the electrode body 10, or may move up and down independently of each other. The drive device includes, for example, an air cylinder, a hydraulic cylinder, a servomotor, and the like.

<Advantages>

In the joining device and the joining method according to the present embodiment, the power supply members 30 that supply power to the joining target members 101 and 102 are located apart from the pressing target portion 105 generated by the pressing members 20, and a power supply function and a pressing function are separated. It is thus possible to substantially prevent the joining target members 101 and 102 from being deformed at the contact portions 30a in contact with the power supply members 30. As a result, the current path P in the joining object 100 can be stabilized, and wear and loss of the power supply members 30 can be substantially prevented. By stabilizing the current path P, heat can be efficiently consumed in the pressing target portion 105, and the energy efficiency can be improved. It is therefore possible to provide a joining device and a joining method in which deterioration of the power supply members 30 is substantially prevented, the current path in the joining object is stabilized, and a decrease in energy efficiency is substantially prevented with a simple configuration.

Hereinafter, other embodiments according to the present disclosure will be described. In the description of these embodiments, the same parts as those of the first embodiment are denoted by the same reference signs, and detailed description thereof is omitted.

### Second Embodiment

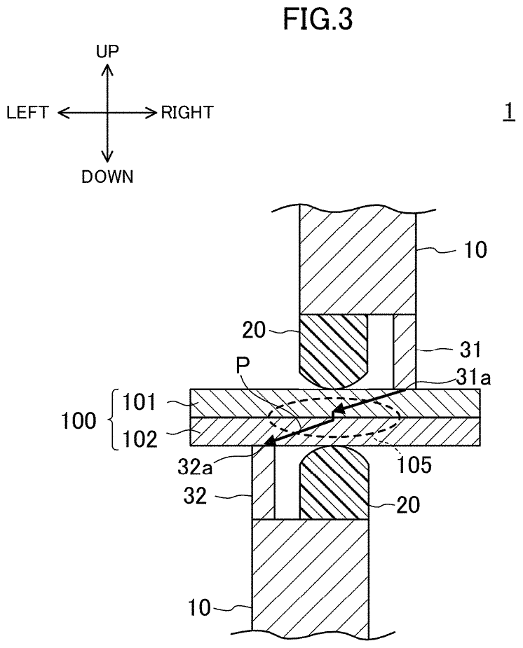

A joining device 1 according to a second embodiment is different from the joining device 1 according to the first embodiment in that power supply members are provided above and below the joining object. In other words, as illustrated in FIG. 3, power supply members 31 and 32 are disposed laterally outside the pressing members 20 and 20 so as to face each other with a pressing target portion 105 pressed by the pressing members 20 and 20 interposed therebetween on both upper and lower sides of the joining object 100.

Specifically, a first power supply member 31 provided above the joining object 100 (on one side in the stacking direction) is disposed with a space apart on the right side of the pressing member 20, and a second power supply member 32 provided below the joining object 100 (on the other side in the stacking direction) is disposed with a space apart on the left side of the pressing member 20. Thus, the first power supply member 31 and the second power supply member 32 face each other with the pressing target portion 105 interposed therebetween and are located diagonally.

The power supply members 31 and 32 can supply power into the joining object 100 through the contact portions 31a and 32a in contact with the surfaces of the joining target members 101 and 102, respectively. Each of the first power supply member 31 and the second power supply member 32 are provided at a position not overlapping the pressing members 20 in the up-down direction. However, when the first power supply member 31 and the second power supply member 32 are energized, the current path P is generated in a diagonal direction indicated by arrows in FIG. 3, and the current path P passes through the pressing target portion 105.

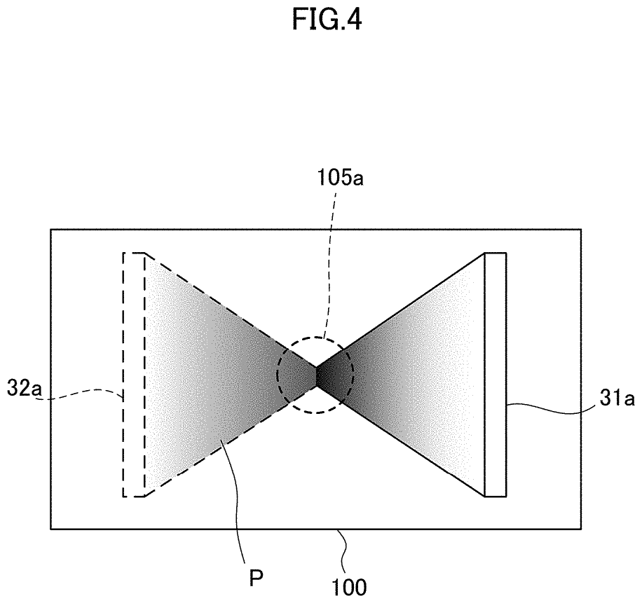

FIG. 4 schematically illustrates a flow of electricity in the joining object 100 in a plan view of the joining object 100 pressed and supplied with power in the second embodiment. For convenience of description, the joining device 1 is omitted in FIG. 4. The contact portions 31a and 32a between the power supply members 31 and 32 and the joining target members 101 and 102 extend along the surfaces of the joining target members 101 and 102. The contact portion 31a of the first power supply member 31 and the contact portion 32a of the second power supply member 32 face each other with the pressing target portion 105 interposed therebetween. When the power supply members 31 and 32 are energized together with the pressing by the pressing members 20, the current path P is generated diagonally, and the current path P passes through the pressing target portion 105. At this time, as indicated by shading in FIG. 4, in the joining object 100 which is being pressed and supplied with power, a current density becomes sparse near the contact portions 31a and 32a, and the current density becomes dense toward a region 105a corresponding to portions in contact with the pressing members.

This configuration can substantially prevent deformation of the joining object 100 in the contact portions 31a and 32a and can more efficiently generate heat in the pressing target portion 105. As compared with known spot welding performed using an electrode in which pressing and power supply are integrated, the joining device according to the present embodiment can perform joining with about one third of heat.

### Third Embodiment

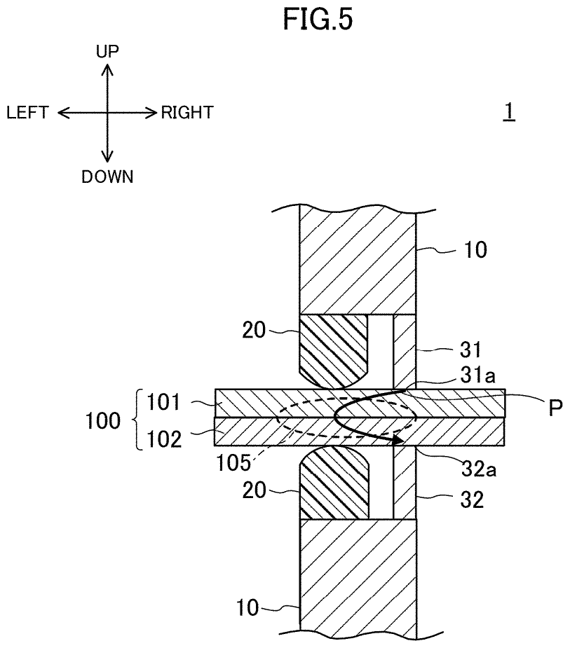

A joining device 1 according to a third embodiment is different from the joining device 1 according to the second embodiment in that two power supply members are disposed on left sides or right sides of the pressing members. As illustrated in FIG. 5, power supply members 31 and 32 are disposed on the right sides of the pressing members 20 and 20 so as to face each other with a pressing target portion 105 pressed by the pressing members 20 and 20 interposed therebetween on both upper and lower sides of the joining object 100.

Specifically, the first power supply member 31 provided above the joining object 100 (on one side in the stacking direction) is disposed with a space apart on the right side of the pressing member 20, and the second power supply member 32 provided below the joining object 100 (on the other side in the stacking direction) is disposed with a space apart on the right side of the pressing member 20. The first power supply member 31 and the second power supply member 32 are disposed at positions overlapping each other in the up-down direction so as to face each other to sandwich the pressing target portion 105 in the up-down direction.

The power supply members 31 and 32 can supply power into the joining object 100 through the contact portions 31a and 32a in contact with the surfaces of the joining target members 101 and 102, respectively. Each of the first power supply member 31 or the second power supply member 32 is provided at a position not overlapping the pressing members 20 in the up-down direction. However, when the power supply members 31 and 32 are energized, the current path P is generated in a direction indicated by an arrow in FIG. 5, and the current path P passes through the pressing target portion 105.

### Fourth Embodiment

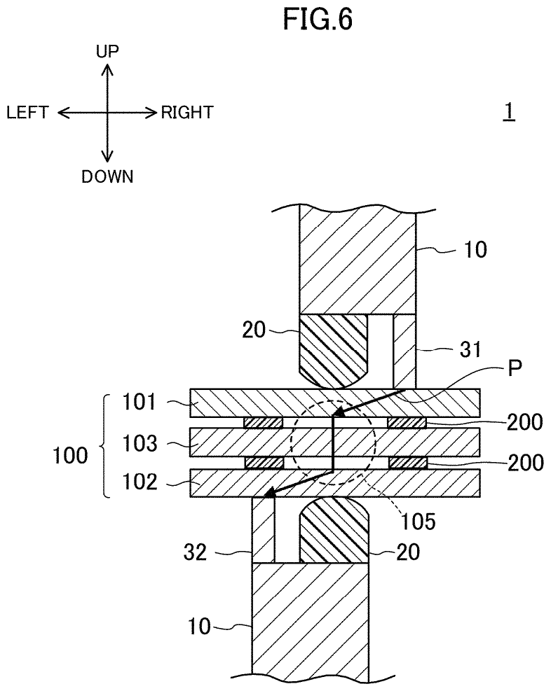

The configuration of the joining object 100 is not limited to the above embodiments. Specifically, in order to control the current path P, the joining object 100 may be configured as illustrated in FIG. 6. A fourth embodiment is another joining method using the joining device 1 according to the second embodiment.

In FIG. 6, the pressing member 20 is made of, for example, a conductor such as metal, and for three joining target members 101, 102, and 103 constituting the joining object 100, an insulating material 200 is interposed between adjacent joining target members in the up-down direction. The insulating material 200 is provided at a position overlapping the power supply members 31 and 32 in the up-down direction and not overlapping the pressing member 20.

When the power supply members 31 and 32 are energized together with the pressing by the pressing member 20, the current path P is formed avoiding a location where the insulating material 200 is provided, and the current path P can be further stabilized and can be more reliably passed through the pressing target portion 105. As described above, in a case where the pressing member 20 is made of a conductor, it is still possible to perform control such that the current path P is formed at a desired joining position by supplying power with the insulating material 200 interposed between the joining target members.

### Fifth Embodiment

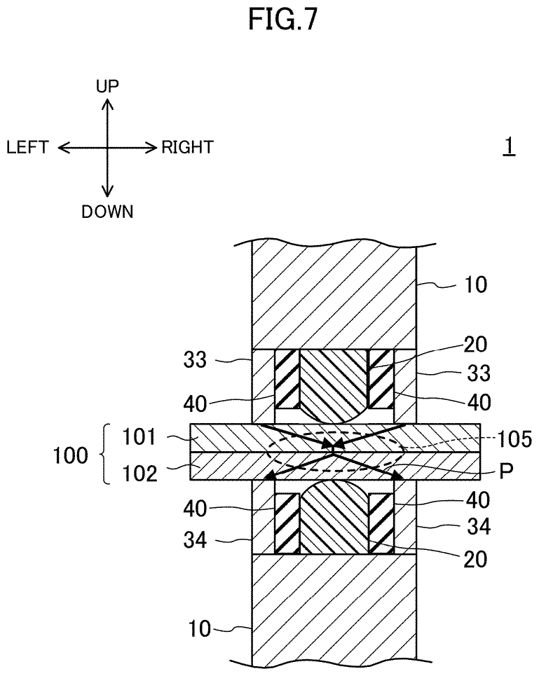

A joining device 1 according to a fifth embodiment is different from the joining device 1 according to the above embodiments in that the power supply members are provided on both left and right sides of the pressing members above and below the joining object. In other words, as illustrated in FIG. 7, power supply members 33 and 34 are disposed on both left and right sides of the pressing members 20 and 20 so as to be disposed both above and below the joining target members 101 and 102, face each other with the pressing target portion 105 pressed by the pressing members 20 interposed therebetween, and be located diagonally.

Specifically, the pressing members 20 are each made of a conductor such as metal, for example, the first power supply members 33 and 33 provided above the joining target members 101 and 102 are disposed with a space apart on the left and right sides of the upper pressing member 20, and the insulating members 40 and 40 are disposed between the first power supply members 33 and 33 and the pressing member 20. The second power supply members 34 and 34 provided below the joining target members 101 and 102 are disposed with a space apart on the left and right sides of the lower pressing member 20, and the insulating members 40 and 40 are disposed between the second power supply members 34 and 34 and the pressing member 20.

The first power supply members 33 and the second power supply members 34 are disposed to face each other with the joining object 100 interposed therebetween in the up-down direction. The first power supply members 33 and 33 and the second power supply members 34 and 34 are provided at positions not overlapping the pressing members 20 in the up-down direction.

When the power supply members 33 and 34 are energized together with the pressing by the pressing members 20, the current path P is generated diagonally as indicated by arrows in FIG. 7. The current path P passes through the pressing target portion 105, and the pressing target portion 105 can generate heat more effectively. As described above, in a case where the pressing member 20 is made of a conductor, it is still possible to control the current path P reliably by supplying power with the insulating members 40 and 40 interposed therebetween.

### Sixth Embodiment

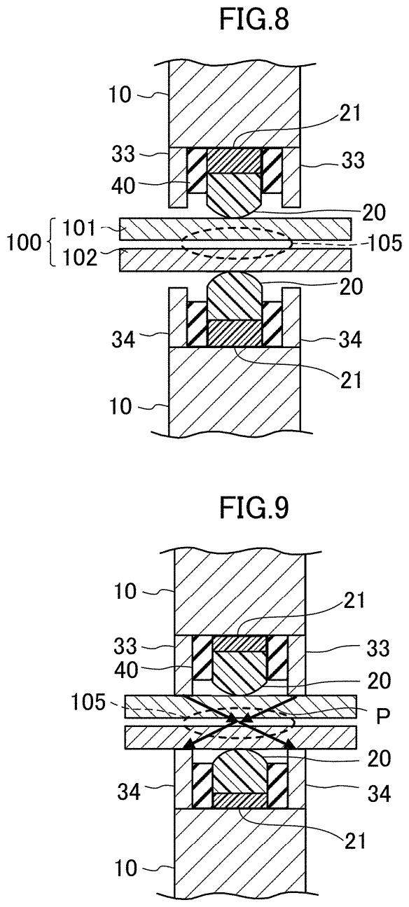

A joining device 1 according to a sixth embodiment has substantially a similar configuration to the configuration of the fifth embodiment, but is different in that the pressing members each have an elastically deformable pressing member support. Specifically, as illustrated in FIG. 8, the pressing member 20 is provided with an elastically deformable pressing member support 21 between the electrode body 10 and the pressing member 20. The pressing member support 21 is, for example, a spring member, and is elastically deformable in the up-down direction.

The pressing member 20 protrudes toward the joining object 100 more than the power supply members 33 and 34 adjacent in the left-right direction. Thus, when the electrode body 10 is moved up and down to bring the pressing members 20 and the power supply members 33 and 34 closer to the joining object 100, the distal ends of the pressing members 20 come into contact with the surfaces of the joining object 100 before coming into contact with the power supply members 33 and 34.

When the electrode body 10 is further brought close to the joining object 100 after the pressing members 20 come into contact with the surface of the joining object 100, as illustrated in FIG. 9, the pressing members 20 press the joining object 100, the pressing member supports 21 are elastically deformed, and the power supply members 33 and 34 come into contact with the surface of the joining object 100 after coming into contact with the pressure members 20.

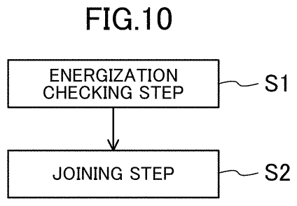

As described above, in a configuration where the elastically deformable pressing member support 21 is provided, and the power supply members 33 and 34 include a joining power source for generating resistance heat in the pressing target portion 105 and a monitoring power source for checking an energization state of the power supply members 33 and 34 to the joining target members 101 and 102, it is possible to perform gradual steps such as an energization checking step S1 and a joining step S2 illustrated in FIG. 10.

The monitoring power source has, for example, an output of about 50 V at maximum, and power is applied from the monitoring power source when power is not output from the joining power source. A contact of the power supply members 33 and 34 with the joining target members 101 and 102 can be detected by detecting a change in voltage by the monitoring power source.

The energization checking step S1 is a step of checking an energization state of the plurality of joining target members 101 and 102 by gradually changing a pressing force by the pressing member 20 in a state where power is supplied between the power supply members 33 and 34 by the monitoring power source and checking whether the current path P can be appropriately secured. In the energization checking step S1, it is possible to check an appropriate pressing force and energization state, check a state of a space between the joining target members, output a process error, and the like, and it is possible to monitor construction parameters while checking a pressing state and balance of the pressing member 20 and the power supply members 33 and 34.

The joining step S2 is a step of supplying power between the power supply members 33 and 34 by the joining power source under conditions such as the construction parameters checked in the energization checking step S1 to join the pressing target portion 105.

As described above, power can be supplied under an appropriate condition that can secure the pressing target portion 105 as the current path P. It is thus possible to improve the energy efficiency by stabilizing the current path P with a simple configuration.

### Seventh Embodiment

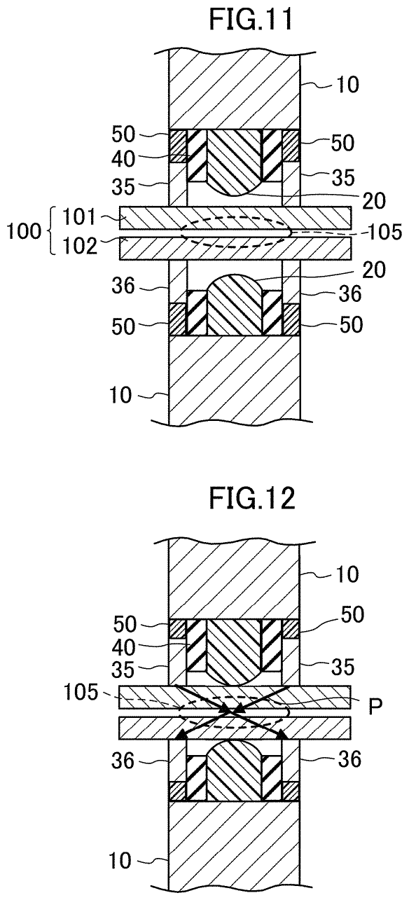

A joining device 1 according to a seventh embodiment has substantially a similar configuration to the configuration of the fifth embodiment, but is different in that power supply members each have an elastically deformable power supply member support. Specifically, as illustrated in FIG. 11, the power supply members 35 and 36 disposed on the upper and lower sides of the joining object 100 and on the left and right sides of the pressing members 20 each include an elastically deformable power supply member support 50 between the electrode body 10 and the power supply member 35 or 36. The power supply member support 50 is, for example, a spring member, and is elastically deformable in the up-down direction.

The power supply members 35 and 36 protrude toward the joining object 100 more than the adjacent pressing members 20. Thus, when the electrode body 10 is moved up and down to bring the pressing members 20 and the power supply members 35 and 36 closer to the joining object 100, the power supply members 35 and 36 come into contact with the surfaces of the joining object 100 before coming into contact with the pressing members 20.

When the electrode body 10 is further brought close to the joining object 100 after the power supply members 35 and 36 come into contact with the surface of the joining object 100, as illustrated in FIG. 12, the power supply member supports 50 are elastically deformed, and the pressing members 20 come into contact with the surface of the joining object 100 after coming into contact with the power supply members 35 and 36. When the electrode body 10 is further brought close to the joining object 100, the pressing force from the pressing members 20 to the joining object 100 is increased while an appropriate pressing force required for power supply is applied to the power supply members 35 and 36 by the elastic deformation of the power supply member supports 50.

As in the sixth embodiment, in a configuration where the power supply members 35 and 36 include the joining power source for generating resistance heat in the pressing target portion 105 and the monitoring power source for checking an energization state of the power supply members 35 and 36 to the joining target members 101 and 102, it is possible to perform gradual steps such as the energization checking step Si and the joining step S2 illustrated in FIG. 10.

As described above, by providing the elastically deformable power supply member support 50, it is possible to apply different appropriate pressing forces to the pressing members 20 and the power supply members 35 and 36 with a simple configuration. It is possible to substantially prevent deformation of the joining object 100 at portions in contact with the power supply members 35 and 36. The current path P can thus be stabilized.

<Other Embodiments>

The above embodiments are examples in which the joining device 1 is applied to welding in which the resistance heat is generated in the pressing target portion of the joining target members, and the joining target members are melted and joined to each other as in the commonly used spot welding. The term “joining” in the claims refers to “welding”. However, the embodiments of the joining device 1 are not limited to the welding. Alternatively, for example, the joining device 1 can also be applied to adhesive joining in which a thermosetting adhesive is applied between the joining target members, resistance heat is generated in the pressing target portion by pressing and power supply by the joining device 1, and the thermosetting adhesive is thermally cured to join the joining target members. In this case, “joining” in the claims refers to “adhesive joining”.

What is claimed is:

1. A joining device that joins a plurality of joining target members being stacked, the joining device comprising:
a pair of pressing members disposed to face each other to sandwich the plurality of joining target members from both sides in a stacking direction of the plurality of joining target members and configured to press the plurality of joining target members; and
a plurality of power supply members disposed on one or both sides in the stacking direction of the plurality of joining target members to sandwich a pressing target portion of the plurality of joining target members by the pressing members, the plurality of power supply members being configured to come into contact with and supply power to the joining target members, wherein
the power supply members are provided at positions not overlapping the pressing members in the stacking direction of the plurality of joining target members, and
the pressing members press the plurality of joining target members while the power supply members supply power to the plurality of joining target members, thereby generating resistance heat in the pressing target portion and joining the plurality of joining target members.

2. The joining device of claim 1, wherein
the power supply members include a first power supply member disposed on one side in the stacking direction of the plurality of joining target members and a second power supply member disposed on the other side in the stacking direction of the plurality of joining target members.

3. The joining device of claim 2, wherein
the first power supply member and the second power supply member each have a contact portion extending along surfaces of the joining target members, and
the contact portion of the first power supply member and the contact portion of the second power supply member face each other with the pressing target portion interposed therebetween.

4. The joining device of claim 1, wherein
the pressing members and the power supply members adjacent to each other in a surface direction of the joining target members are provided at a distal end of an electrode body.

5. The joining device of claim 2, wherein
the pressing members and the power supply members adjacent to each other in a surface direction of the joining target members are provided at a distal end of an electrode body.

6. The joining device of claim 3, wherein
the pressing members and the power supply members adjacent to each other in a surface direction of the joining target members are provided at a distal end of an electrode body.

7. The joining device of claim 4, wherein
the pressing members are each provided with a pressing member support between the corresponding pressing member and the electrode body, the pressing member support being elastically deformable in the stacking direction of the plurality of joining target members.

8. The joining device of claim 5, wherein
the pressing members are each provided with a pressing member support between the corresponding pressing member and the electrode body, the pressing member support being elastically deformable in the stacking direction of the plurality of joining target members.

9. The joining device of claim 6, wherein
the pressing members are each provided with a pressing member support between the corresponding pressing member and the electrode body, the pressing member support being elastically deformable in the stacking direction of the plurality of joining target members.

10. The joining device of claim 4, wherein
the power supply members are each provided with a power supply member support between the corresponding power supply member and the electrode body, the power supply member support being elastically deformable in the stacking direction of the plurality of joining target members.

11. The joining device of claim 5, wherein
the power supply members are each provided with a power supply member support between the corresponding power supply member and the electrode body, the power supply member support being elastically deformable in the stacking direction of the plurality of joining target members.

12. The joining device of claim 6, wherein
the power supply members are each provided with a power supply member support between the corresponding power supply member and the electrode body, the power supply member support being elastically deformable in the stacking direction of the plurality of joining target members.

13. The joining device of claim 1, wherein
the pressing members are each made of a conductor, and an insulating member is provided between the power supply members and the pressing members.

14. The joining device of claim 1, wherein
the power supply members include a joining power source configured to generate resistance heat in the pressing target portion, and a monitoring power source configured to check an energization state of the power supply members to the joining target members.

15. A joining method of joining a plurality of joining target members being stacked, the joining method comprising:
by using a pair of pressing members disposed to face each other to sandwich the plurality of joining target members from both sides in a stacking direction of the plurality of joining target members and configured to press the plurality of joining target members, and
using a plurality of power supply members disposed on one or both sides of in the stacking direction of the plurality of joining target members to sandwich a pressing target portion of the plurality of joining target members by the pressing members, the plurality of power supply members being configured to come into contact with and supply power to the joining target members, wherein
pressing the plurality of joining target members by the pressing members and supplying power to the plurality of joining target members at positions not overlapping the pressing members in the stacking direction of the plurality of joining target members by the power supply members, to generate resistance heat in the pressing target portion and join the plurality of joining target members.

16. The joining method of claim 15, wherein
as the power supply members, a first power supply member disposed on one side in the stacking direction of the plurality of joining target members and a second power supply member disposed on the other side in the stacking direction of the plurality of joining target members are used.

17. The joining method of claim 16, wherein
the first power supply member and the second power supply member each have a contact portion extending along surfaces of the joining target members, and
the contact portion of the first power supply member and the contact portion of the second power supply member face each other with the pressing target portion interposed therebetween.

18. The joining method of claim 17, wherein
the power supply members supply power by using the pressing members each made of a conductor in a state where an insulating material is interposed between the plurality of joining target members.

19. The joining method of claim 18, further comprising:
an energization checking step of checking an energization state of the plurality of joining target members by gradually changing a pressing force by the pressing members in a state where power is supplied between the power supply members by the monitoring power source, and
a joining step of supplying power between the power supply members by the joining power source under a condition checked in the energization checking step, wherein
the power supply members include a joining power source configured to generate resistance heat in the pressing target portion, and a monitoring power source configured to check an energization state of the power supply members to the joining target members.
